(19) United States
(12) Patent Application Publication
(10) Pub. No.: US 2001/0044382 A1
(43) Pub. Date: Nov. 22, 2001

(54) Herbicide

(76) Inventor: Willy Ruegg, Gipf-Oberfrick (CH)

Correspondence Address: SYNGENTA CROP PROTECTION , INC., PATENT AND TRADEMARK DEPARTMENT, 410 SWING ROAD, GREENSBORO, NC, 27409, US

(21) Appl. No.: 09/748,347

(22) Filed: Dec. 26, 2000

Related U.S. Application Data
(63) Continuation of application No. PCT/EP99/04374, filed on Jun. 24, 1999.

(30) Foreign Application Priority Data
Jun. 26, 1998 (CH) 1373/98

(51) Int. Cl. A01N 43/647; A01N 43/713

(52) U.S. Cl. 504/139; 504/149

(57) ABSTRACT

A herbicidal composition that, in addition to comprising customary inert formulation adjuvants, comprises a compound of formula I

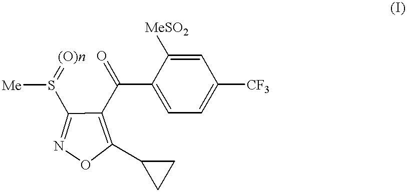

wherein n is 0 or 1, and b) a synergistically effective amount of one or more herbicides. The compositions according to the invention may also comprise a safener.

The present invention relates to a novel synergistic herbicidal composition comprising a herbicidal active ingredient combination that is suitable for the selective control of weeds in crops of useful plants, for example in maize crops.

The invention relates also to a method of controlling weeds in crops of useful plants, and to the use of the novel composition for that purpose.

The compounds of formula I

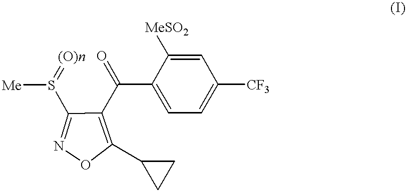

wherein n is 0 or 1 have herbicidal activity, as described, for example, in WO 97/43270.

Surprisingly, it has now been shown that a combination of variable amounts of active ingredients, that is, of an active ingredient of formula I with one or more of the active ingredients of formulae 2.1 to 2.33 listed below, which are known and some of which are also commercially available, exhibits a synergistic action that is capable of controlling, both pre-emergence and post-emergence, the majority of weeds occurring especially in crops of useful plants.

There is therefore proposed in accordance with the present invention a novel synergistic composition for selective weed control that, in addition to comprising customary inert formulation adjuvants, comprises as active ingredient a mixture of

a) a compound of formula I

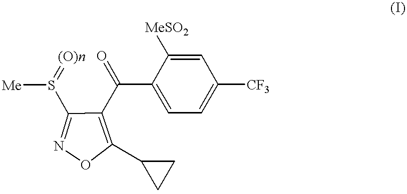

wherein n is 0 or 1, and

b) a synergistically effective amount of one or more compounds selected from a compound of formula 2.1

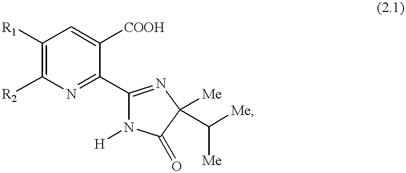

wherein R₁ is CH₂—OMe, ethyl or hydrogen;

R₂ is hydrogen or R₁ and R₂ together form the group —CH═CH—CH═CH—;

and a compound of formula 2.2

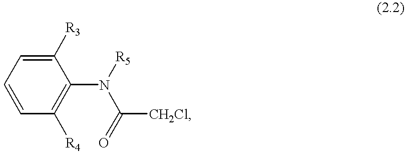

wherein R₃ is ethyl, R₄ is methyl or ethyl and R₅ is —CH(Me)—CH₂OMe, <S>—CH(Me)—CH₂OMe, CH₂OMe or CH₂O—CH₂CH₃;

and a compound of formula 2.3

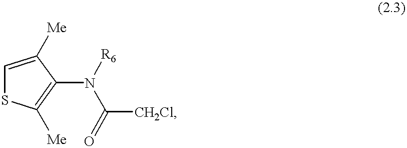

wherein R₆ is CH(Me)—CH₂OMe or <S>CH(Me)—CH₂OMe;

and a compound of formula 2.4

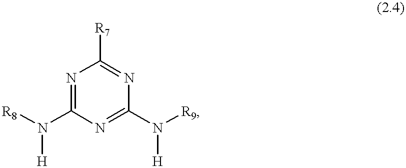

wherein R₇ is chlorine or SMe, R₈ is ethyl and R₉ is ethyl, isopropyl or tert-butyl;

and a compound of formula 2.5

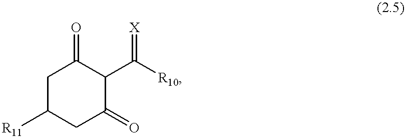

wherein R₁₀ is ethyl or n-propyl, R₁₁ is COO⁻ ½ Ca⁺⁺, —CH₂—CH(Me)S—CH₂CH₃ or the group

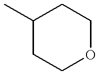

and X is oxygen, N—O—CH₂CH₃ or N—O—CH₂CH═CH—Cl;

and a compound of formula 2.6

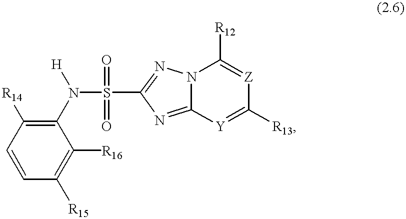

wherein R₁₂ is hydrogen, methoxy or ethoxy, R₁₃ is Me, methoxy or fluorine, R₁₄ is COOMe, fluorine or chlorine, R₁₅ is hydrogen or Me, Y is methine or nitrogen, Z is methine or nitrogen and R₁₆ is fluorine or chlorine;

and a compound of formula 2.7

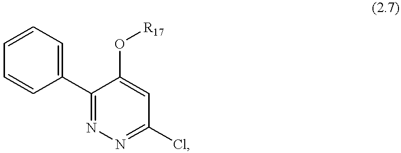

wherein R₁₇ is hydrogen or —C(O)—S-n-octyl;

and a compound of formula 2.8

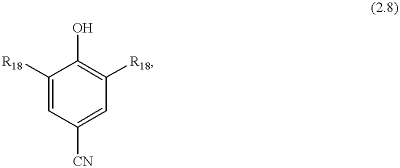

wherein R₁₈ is bromine or iodine;

and a compound of formula 2.9

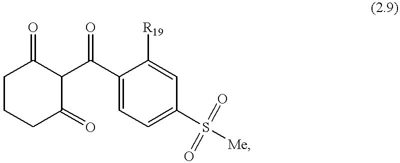

wherein R₁₉ is chlorine or nitro;

and a compound of formula 2.10

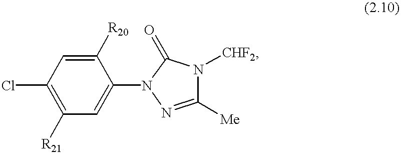

wherein R₂₀ is fluorine or chlorine and R₂, is —CH₂—CH(Cl)—COOCH₂CH₃ or —NH—SO₂Me;

and a compound of formula 2.11

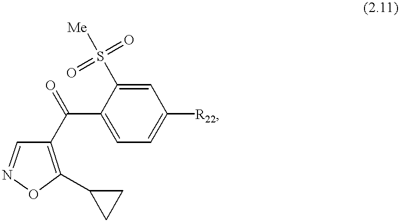

wherein R₂₂ is trifluoromethyl or chlorine;

and a compound of formula 2.12

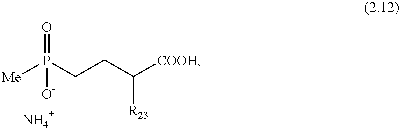

wherein R₂₃ is NH₂ or <S>NH₂;

and a compound of formula 2.13

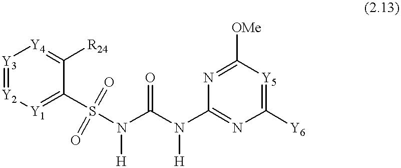

wherein Y₁ is nitrogen, methine or N—Me, Y₂ is nitrogen, methine or C—I, Y₃ is methine, Y₄ is methine, or Y₃ and Y₄ together are sulfur or C—Cl, Y₅ nitrogen or methine, Y₆ is methyl or methoxy and R₂₄ is CONMe₂, COOMe, CH₂—CH₂CF₃ or SO₂CH₂CH₃, or sodium salts thereof;

and the compound of formula 2.14

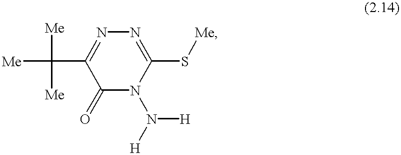

and the compound of formula 2.15

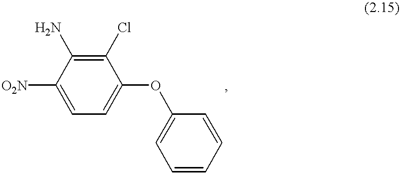

and the compound of formula 2.16

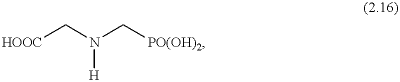

and the compound of formula 2.17

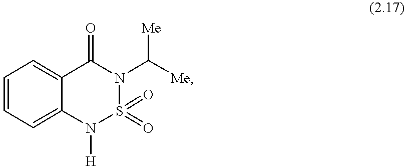

and the compound of formula 2.18

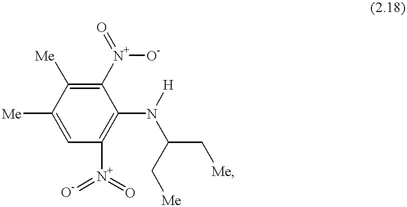

and the compound of formula 2.19

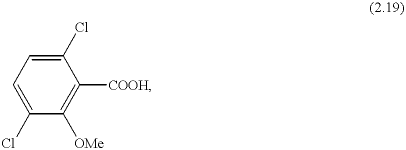

and the compound of formula 2.20

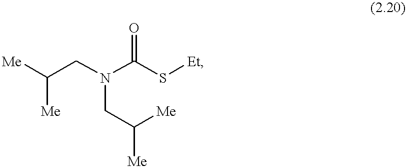

and the compound of formula 2.21

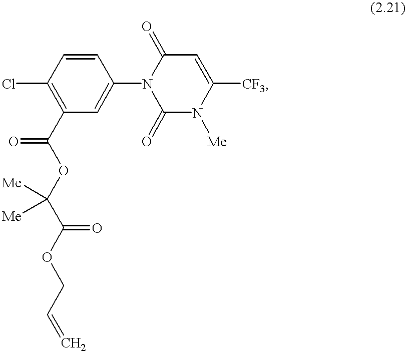

and the compound of formula 2.22

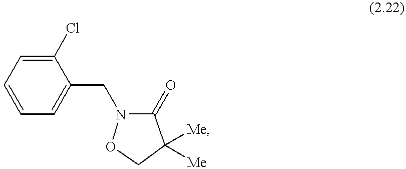

and the compound of formula 2.23

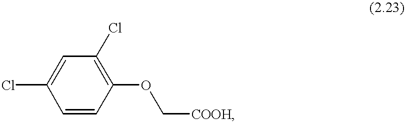

and the compound of formula 2.24

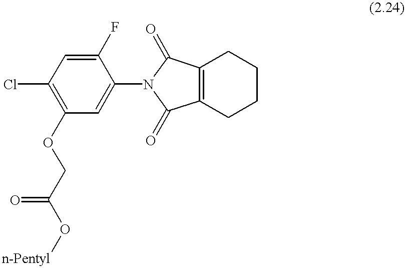

and the compound of formula 2.25

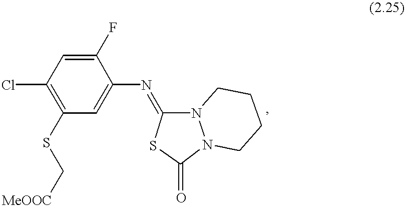

and the compound of formula 2.26

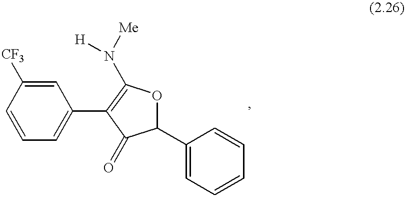

and the compound of formula 2.27

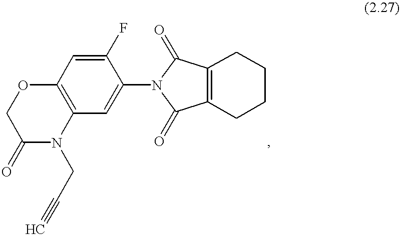

and the compound of formula 2.28

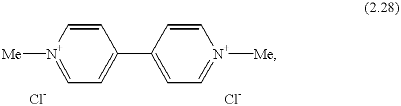

and the compound of formula 2.29

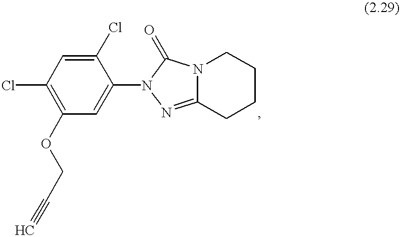

and the compound of formula 2.30

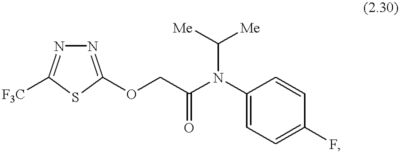

and the compound of formula 2.31

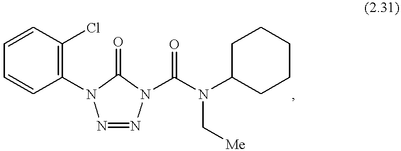

and the compound of formula 2.32

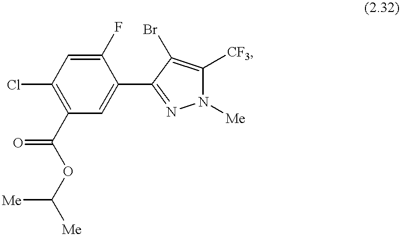

and the compound of formula 2.33

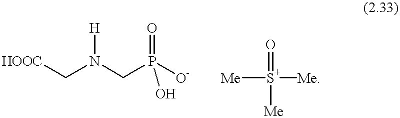

In the above formulae, “Me” is a methyl group.

It is extremely surprising that the combination of the active ingredient of formula I with one or more active ingredients selected from formulae 2.1 to 2.33 exceeds the additive effect on the weeds to be controlled that is to be expected in principle, and thus broadens the range of action of the individual active ingredients especially in two respects: Firstly, the rates of application of the individual compounds of formulae 1 and 2.1 to 2.33 are reduced while a good level of action is maintained and, secondly, the composition according to the invention achieves a high level of weed control also in those cases where the individual substances, in the range of low rates of application, have become unusable from the agronomic standpoint. The result is a considerable broadening of the spectrum of weeds and an additional increase in selectivity in respect of the crops of useful plants, as is necessary and desirable in the event of an unintentional overdose of active ingredient. The composition according to the invention, while retaining excellent control of weeds in crops of useful plants, also enables greater flexibility in succeeding crops.

The composition according to the invention can be used against a large number of agronomically important weeds, such as Stellaria, Nasturtium, Agrostis, Digitaria, Avena, Setaria, Sinapis, Lolium, Solanum, Phaseolus, Echinochloa, Scirpus, Monochoria, Sagittaria, Bromus, Alopecurus, Sorghum halepense, Rottboellia, Cyperus, Abutilon, Sida, Xanthium, Amaranthus, Chenopodium, Ipomoea, Chrysanthemum, Galium, Viola and Veronica. The composition according to the invention is suitable for all methods of application conventionally used in agriculture, e.g. pre-emergence application, post-emergence application and seed dressing. The composition according to the invention is suitable especially for controlling weeds in crops of useful plants, such as cereals, rape, sugar beet, sugar cane, plantation crops, rice, maize and soybeans, and also for non-selective weed control.

“Crops” are to be understood to mean also those crops which have been made tolerant to herbicides or classes of herbicides as a result of conventional methods of breeding or genetic engineering.

The compounds of formulae 2.1 to 2.13 are known by the names imazamox, imazethapyr, imazaquine, imazapyr, metolachlor, alachlor, acetochlor, dimethenamid, atrazine, terbuthylazine, simazine, terbutyrn, prohexadione calcium, sethoxydim, clethodim, tepraloxydim, flumetsulam, metosulam, pyridate, bromoxynil, ioxynil, sulcotrione, carfentrazone, sulfentrazone, isoxaflutole, glufosinate, primisulfuron, prosulfuron, rimsulfuron, halosulfuron, nicosulfuron and thifensulfuron and are described in the Pesticide Manual, eleventh ed., British Crop Protection Council, 1997 under the entry numbers 412, 415, 414, 413, 493, 14, 6, 240, 34, 692, 651, 693, 595, 648, 146, 49, 339, 495, 626, 88, 425, 664, 112, 665, 436, 382, 589, 613, 644, 389, 519 and 704. The compound of formula 2.13 wherein Y₁, Y₃ and Y₄ are methine, Y₂ is C—I, R₂₄ is COOMe, Y₅ is nitrogen and Y₆ is methyl is known by the name iodosulfuron (especially the sodium salt) from AGROW No. 296, Jan. 16, 1998, page 22.

The S enantiomer of the compound of formula 2.12 is registered under the CAS—Reg. No. [35597-44-5]. Compounds of the general formula 2.2, aRS,1′S(−)N-(1′-methyl-2′-methoxyethyl)-N-chloroacetyl-2-ethyl-6-methylaniline, and of the general formula 2.3, (1S,aRS)-2-chloro-N-(2,4-dimethyl-3-thienyl)-N-(2-methoxy-1-methylethyl)-acetamide, are described, for example, in WO 97/34485.

The compound of formula 2.9 wherein R₁₉ is NO₂ is known by the name mesotrione and is described, for example, in U.S. Pat. No. 5,006,158. The compound of formula 2.6 wherein R₁₂ is ethoxy, R₁₃ is fluorine, Y is methine, R₁₄ is methoxycarbonyl, R₁₅ is hydrogen and R₁₆ is chlorine is known by the name cloransulam, for example from AGROW No. 261, Aug. 2, 1996, page 21.

Furthermore, the following compounds of the composition according to the invention are described in the Pesticide Manual, eleventh ed., British Crop Protection Council, 1997:

| Compound of formula (name) | Pesticide Manual eleventh ed., Entry No.: |
|---|---|
| 2.14 (metribuzin) | 497 |
| 2.15 (aclonifen) | 8 |
| 2.16 (glyphosate) | 383 |
| 2.17 (bentazone) | 65 |
| 2.18 (pendimethalin) | 557 |
| 2.19 (dicamba) | 210 |
| 2.20 (butylate) | 100 |
| 2.22 (clomazone) | 150 |
| 2.23 (2,4-D) | 192 |
| 2.24 (flumiclorac) | 340 |
| 2.25 (fluthiacet-methyl) | 359 |
| 2.26 (flurtamone) | 356 |
| 2.27 (flumioxazin) | 341 |
| 2.28 (paraquat) | 550 |
| 2.29 (azafenidin) | 37 |
| 2.30 (fluthiamid) | 51 |
| 3.33 (sulfosate) | 383 |

The compound of formula 2.7 wherein R₁₇ is hydrogen and the preparation thereof are described in U.S. Pat. No. 3,790,571, and the compound of formula 2.6 wherein R₁₂ is ethoxy, Z is nitrogen, R₁₃ is fluorine, R₁₄ is chlorine, R₁₅ is hydrogen and R₁₆ is chlorine is described in U.S. Pat. No. 5,498,773.

The compound of formula 2.21 and the preparation thereof are described in U.S. Pat. No. 5,183,492, and the compound of formula 2.22 is described under the name isoxachlortole in AGROW No. 296, Jan. 16, 1998, page 22. The compound of formula 2.31 is described under the name fentrazamide in The 1997 British Crop Protection Conference—Weeds, Conference Proceedings Vol. 1,2-8, pages 67 to 72, and the compound of formula 2.32 is described under the name JV 485 (isoxapropazol) in The 1997 British Crop Protection Conference—Weeds, Conference Proceedings Vol. 1, 3A-2, pages 93 to 98.

Preferred synergistic mixtures according to the invention comprise as active ingredients a compound of formula I and either a compound of formula 2.2.1

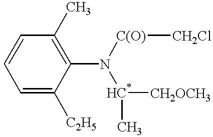

(2.2.1, aRS,1′S(−)N-(1′-methyl-2′-methoxyethyl)-N-chloroacetyl-2-ethyl-6-methylaniline), or a compound of formula 2.2.2

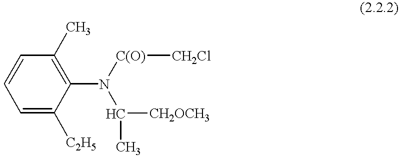

or a compound of formula 2.2 wherein R₃ is ethyl, R₄ is methyl and R₅ is ethoxymethyl, or a compound of formula 2.2 wherein R₃ is ethyl, R₄ is ethyl and R₅ is methoxymethyl, or a compound of formula 2.3, or a compound of formula 2.4 wherein R₇ is chlorine, R₈ is ethyl and R₉ is isopropyl, or R₇ is chlorine, R₈ is ethyl and R₉ is tert-butyl, or a compound of formula 2.6 wherein R₁₂ is hydrogen, Z is methine, R₁₃ is methyl, Y is nitrogen, R₁₄ is fluorine, R₁₅ is hydrogen and R₁₆ is fluorine, or R₁₂ is methoxy, Z is methine, R₁₃ is methoxy, Y is methine, R₁₄ is chlorine, R₁₅ is methyl and R₁₆ is chlorine, or a compound of formula 2.7 wherein R₁₇ is —C(O)—S-n-octyl, or a compound of formula 2.9, or a compound of formula 2.11 wherein R₂₂ is trifluoromethyl, or a compound of formula 2.12, or a compound of formula 2.13 wherein Y₁ is nitrogen, Y₂, Y₃ and Y₄ are methine, R₂₄ is dimethylaminocarbonyl and Y₅ is methine, or Y₁, Y₂, Y₃ and Y₄ are methine, R₂₄ is methoxycarbonyl and Y₅ is methine, or Y₁, Y₂, Y₃ and Y₄ are methine, R₂₄ is 3-trifluoropropyl and Y₅ is nitrogen, or Y₁ is nitrogen, Y₂, Y₃ and Y₄ are methine, R₂₄ is ethylsulfonyl and Y₅ is methine, or Y₁ is N—Me, Y₂ is nitrogen, Y₃ and Y₄ together are C—Cl, R₂₄ is methoxycarbonyl and Y₅ is methine, or a compound of formula 2.16, or a compound of formula 2.18, or a compound of formula 2.19, or a compound of formula 2.30. In a further group of preferred synergistic mixtures according to the invention the mixtures comprise as active ingredients a compound of formula 1, a compound of formula 2.2.1

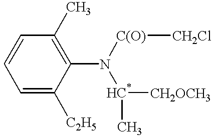

(2.2.1, aRS,1′S(−)N-(1′-methyl-2′-methoxyethyl)-N-chloroacetyl-2-ethyl-6-methylaniline), and a compound selected from formula 2.4 wherein R₇ is chlorine, R₈ is ethyl and R₉ is isopropyl, or R₇ is chlorine, R₈ is ethyl and R₉ is tert-butyl, and formula 2.6 wherein R₁₂ is hydrogen, Z is methine, R₁₃ is methyl, Y is nitrogen, R₁₄ is fluorine, R₁₅ is hydrogen and R₁₆ is fluorine, or R₁₂ is methoxy, Z is methine, R₁₃ is methoxy, Y is methine, R₁₄ is chlorine, R₁₅ is methyl and R₁₆ is chlorine, and formula 2.7 wherein R₁₇ is —C(O)—S-n-octyl, and formula 2.13 wherein Y₁ is nitrogen, Y₂, Y₃ and Y₄ are methine, R₂₄ is dimethylaminocarbonyl and Y₅ is methine, or Y₁, Y₂, Y₃ and Y₄ are methine, R₂₄ is methoxyarbonyl and Y₅ is methine, or Y₁, Y₂, Y₃ and Y₄ are methine, R₂₄ is 3-trifluoropropyl and Y₁ is nitrogen, or Y₁ is nitrogen, Y₂, Y₃ and Y₄ are methine, R₂₄ is ethylsulfonyl and Y₅ is methine, or Y₁ is N—Me, Y₂ is nitrogen, Y₃ and Y₄ together are C—Cl, R₂₄ is methoxycarbonyl and Y₅ is methine, and formula 2.9, and formula 2.11 wherein R₂₂ is trifluoromethyl, and formula 2.12, and formula 2.16, and formula 2.18, and formula 2.19.

Combinations of compounds of formula I with the compound of formula 2.2.1

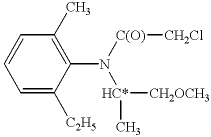

(2.2.1, aRS,1′S(−)N-(1′-methyl-2′-methoxyethyl)-N-chloroacetyl-2-ethyl-6-methylaniline) have proved to be especially effective compositions.

The composition according to the invention comprises the active ingredient of formula I and the active ingredients of formulae 2.1 to 2.33 in any mixing ratio, but usually has an excess of one component over the others. Generally, the mixing ratios (ratios by weight) of the active ingredient of formula I and the mixing partners of formulae 2.1 to 2.33 are from 1:2000 to 2000:1, especially from 200:1 to 1:200.

The rate of application may vary within wide limits and depends on the nature of the soil, the method of application (pre- or post-emergence; seed dressing; application to the seed furrow; no tillage application etc.), the useful plant, the weed to be controlled, the prevailing climatic conditions, and other factors governed by the method of application, the time of application and the target crop. The active ingredient mixture according to the invention can generally be applied at a rate of from 1 to 5000 g of active ingredient mixture/ha.

The mixtures of the compound of formula I with the compounds of formulae 2.1 to 2.33 may be used in unmodified form, that is to say as obtained in the synthesis. Preferably, however, they are formulated in customary manner, together with the adjuvants conventionally used in formulation technology, such as solvents, solid carriers or surfactants, for example into emulsifiable concentrates, directly sprayable or dilutable solutions, dilute emulsions, wettable powders, soluble powders, dusts, granules or microcapsules. As with the nature of the compositions, the methods of application, such as spraying, atomising, dusting, wetting, scattering or pouring, are chosen in accordance with the intended objectives and the prevailing circumstances.

The formulations, i.e. the compositions, preparations or mixtures comprising the compounds (active ingredients) of formulae I and 2.1 to 2.33 and, where appropriate, one or more solid or liquid formulation adjuvants, are prepared in a manner known per se, e.g. by intimately mixing and/or grinding the active ingredients with the formulation adjuvants, e.g. solvents or solid carriers. In addition, surface-active compounds (surfactants) may also be used in the preparation of the formulations.

Examples of solvents and solid carriers are given, for example, in WO 97/34485, page 6.

Depending on the nature of the compound of formula I to be formulated, suitable surface-active compounds are non-ionic, cationic and/or anionic surfactants and surfactant mixtures having good emulsifying, dispersing and wetting properties.

Examples of suitable anionic, non-ionic and cationic surfactants are listed, for example, in

Also suitable in the preparation of the herbicidal compositions according to the invention are the surfactants conventionally used in formulation technology, which are described, inter alia, in “McCutcheon's Detergents and Emulsifiers Annual” MC Publishing Corp., Ridgewood New Jersey, 1981, Stache, H., “Tensid-Taschenbuch”, Carl HanserVerlag, MunichNienna, 1981 and M. and J. Ash, “Encyclopedia of Surfactants”, Vol 1-Ill, Chemical Publishing Co., New York, 1980-81.

The herbicidal formulations usually contain from 0.1 to 99% by weight, especially from 0.1 to 95% by weight, of active ingredient mixture comprising a compound of formula I and the compounds of formulae 2.1 to 2.33, from 1 to 99.9% by weight of a solid or liquid formulation adjuvant, and from 0 to 25% by weight, especially from 0.1 to 25% by weight, of a surfactant.

Whereas commercial products are usually formulated as concentrates, the end user will normally employ dilute formulations. The compositions may also comprise further ingredients, such as stabilisers, e.g. vegetable oils or epoxidised vegetable oils (epoxidised coconut oil, rapeseed oil or soybean oil), antifoams, e.g. silicone oil, preservatives, viscosity regulators, binders, tackifiers, and also fertilisers or other active ingredients. Preferred formulations have especially the following compositions: (%=percent by weight)

| | |
|---|---|
| Emulsifiable concentrates: | |
| active ingredient mixture: | 1 to 90%, preferably 5 to 20% |
| surfactant: | 1 to 30%, preferably 10 to 20% |
| liquid carrier: | 5 to 94%, preferably 70 to 85% |
| Dusts: | |
| active ingredient mixture: | 0.1 to 10%, preferably 0.1 to 5% |
| solid carrier: | 99.9 to 90%, preferably 99.9 to 99% |
| Suspension concentrates: | |
| active ingredient mixture: | 5 to 75%, preferably 10 to 50% |
| water: | 94 to 24%, preferably 88 to 30% |
| surfactant: | 1 to 40%, preferably 2 to 30% |
| Wettable powders: | |
| active ingredient mixture: | 0.5 to 90%, preferably 1 to 80% |
| surfactant: | 0.5 to 20%, preferably 1 to 15% |
| solid carrier: | 5 to 95%, preferably 15 to 90% |
| Granules: | |
| active ingredient mixture: | 0.1 to 30%, preferably 0.1 to 15% |
| solid carrier: | 99.5 to 70%, preferably 97 to 85% |

The following Examples illustrate the invention further, but do not limit the invention.

| F1. Emulsifiable concentrates | a) | b) | c) | d) |
|---|---|---|---|---|
| active ingredient mixture | 5% | 10% | 25% | 50% |
| calcium dodecylbenzenesulfonate | 6% | 8% | 6% | 8% |
| castor oil polyglycol ether | 4% | — | 4% | 4% |
| (36 mol of ethylene oxide) | | | | |
| octylphenol polyglycol ether | — | 4% | — | 2% |
| (7-8 mol of ethylene oxide) | | | | |
| cyclohexanone | — | — | 10% | 20% |
| arom. hydrocarbon mixture | 85% | 78% | 55% | 16% |
| C₉-C₁₂ | | | | |

Emulsions of any desired concentration can be obtained from such concentrates by dilution with water.

| F2. Solutions | a) | b) | c) | d) |
|---|---|---|---|---|
| active ingredient mixture | 5% | 10% | 50% | 90% |
| 1-methoxy-3-(3-methoxy- | | | | |
| propoxy)-propane | — | 20% | 20% | — |
| polyethylene glycol MW 400 | 20% | 10% | — | — |
| N-methyl-2-pyrrolidone | — | — | 30% | 10% |
| arom. hydrocarbon mixture | 75% | 60% | — | — |
| C₉-C₁₂ | | | | |

The solutions are suitable for use in the form of microdrops.

| F3. Wettable powders | a) | b) | c) | d) |
|---|---|---|---|---|
| active ingredient mixture | 5% | 25% | 50% | 80% |
| sodium lignosulfonate | 4% | — | 3% | — |
| sodium lauryl sulfate | 2% | 3% | — | 4% |
| sodium diisobutylnaphthalene- | — | 6% | 5% | 6% |
| sulfonate | | | | |
| octylphenol polyglycol ether | — | 1% | 2% | — |
| (7-8 mol of ethylene oxide) | | | | |
| highly dispersed silicic acid | 1% | 3% | 5% | 10% |
| kaolin | 88% | 62% | 35% | — |

The active ingredient is mixed thoroughly with the adjuvants and the mixture is thoroughly ground in a suitable mill, affording wettable powders which can be diluted with water to give suspensions of any desired concentration.

| F4. Coated granules | a) | b) | c) |
|---|---|---|---|
| active ingredient mixture | 0.1% | 5% | 15% |
| highly dispersed silicic acid | 0.9% | 2% | 2% |
| inorganic carrier | 99.0% | 93% | 83% |
| ( [symbol] 0.1-1 mm) | | | |
| e.g. CaCO₃ or SiO₂ | | | |

The active ingredient is dissolved in methylene chloride and applied to the carrier by spraying, and the solvent is then evaporated off in vacuo.

| F5. Coated granules | a) | b) | c) |
|---|---|---|---|
| active ingredient mixture | 0.1% | 5% | 15% |
| polyethylene glycol MW 200 | 1.0% | 2% | 3% |
| highly dispersed silicic acid | 0.9% | 1% | 2% |
| inorganic carrier | 98.0% | 92% | 80% |
| ( [symbol] 0.1-1 mm) | | | |
| e.g. CaCO₃ or SiO₂ | | | |

The finely ground active ingredient is uniformly applied, in a mixer, to the carrier moistened with polyethylene glycol. Non-dusty coated granules are obtained in this manner.

| F6. Extruder granules | a) | b) | c) | d) |
|---|---|---|---|---|
| active ingredient mixture | 0.1% | 3% | 5% | 15% |
| sodium lignosulfonate | 1.5% | 2% | 3% | 4% |
| carboxymethylcellulose | 1.4% | 2% | 2% | 2% |
| kaolin | 97.0% | 93% | 90% | 79% |

The active ingredient is mixed and ground with the adjuvants, and the mixture is moistened with water. The mixture is extruded and then dried in a stream of air.

| F7. Dusts | a) | b) | c) |
|---|---|---|---|
| active ingredient mixture | 0.1% | 1% | 5% |
| talcum or Champagne chalk | 39.9% | 49% | 35% |
| kaolin | 60.0% | 50% | 60% |

Ready-to-use dusts are obtained by mixing the active ingredient with the carriers and grinding the mixture in a suitable mill.

| F8. Suspension concentrates | a) | b) | c) | d) |
|---|---|---|---|---|
| active ingredient mixture | 3% | 10% | 25% | 50% |
| ethylene glycol | 5% | 5% | 5% | 5% |
| nonylphenol polyglycol ether | — | 1% | 2% | — |
| (15 mol of ethylene oxide) | | | | |
| sodium lignosulfonate | 3% | 3% | 4% | 5% |
| carboxymethylcellulose | 1% | 1% | 1% | 1% |
| 37% aqueous formaldehyde | 0.2% | 0.2% | 0.2% | 0.2% |
| solution | | | | |
| silicone oil emulsion | 0.8% | 0.8% | 0.8% | 0.8% |
| water | 87% | 79% | 62% | 38% |

The finely ground active ingredient is intimately mixed with the adjuvants, giving a suspension concentrate from which suspensions of any desired concentration can be obtained by dilution with water.

It is often more practical for the compound of formula I and the mixing partner or partners of formulae 2.1 to 2.33 to be formulated separately and to be brought together in the desired mixing ratio in the applicator in the form of a “tank mixture” in water shortly before application.

Biological Examples:

A synergistic effect exists whenever the action of the active ingredient combination of a compound of formula I with the compounds of formulae 2.1 to 2.33 is greater than the sum of the actions of the active ingredients applied separately.

The herbicidal action to be expected We for a given combination of two herbicides can be calculated as follows (see COLBY, S. R., “Calculating synergistic and antagonistic response of herbicide combinations”, Weeds 15, pages 20-22, 1967):

We=X+[Y·(100−X)/100]

wherein:

X=percentage herbicidal action on treatment with the compound of formula I at a rate of application of p kg per hectare, compared with the untreated control (=0%).

Y=percentage herbicidal action on treatment with a compound of formula 2.1 to 2.33 at a rate of application of q kg per hectare, compared with the untreated control.

We=expected herbicidal action (percentage herbicidal action compared with the untreated control) following treatment with the compounds of formulae I and 2.1 to 2.33 at a rate of application of p+q kg of active ingredient per hectare.

When the action actually observed is greater than the value to be expected We, there is a synergistic effect.

The synergistic effect of the combinations of a compound of formula I with the compounds of formulae 2.1 to 2.33 is demonstrated in the following Examples.

Experiment Description—Post-emergence Test:

The test plants are grown to the 2- to 3-leaf stage in plastics pots under greenhouse conditions. A standard soil is used as cultivation substrate. At the 2- to 3-leaf stage, the herbicide is applied to the test plants on its own and as a mixture. The application is carried out using an aqueous suspension of the test compounds in 500 liters of water/ha. The rates of application depend on the optimum doses ascertained under field conditions and greenhouse conditions. The tests are evaluated after 20 days (% action, 100%=plant has died, 0%=no phytotoxic action). The results are given in the following Tables 1 to 3.

The compound of formula I wherein n is 0 is designated compound of formula Ia. The compound of formula I wherein n is 1 is designated compound of formula Ib.

TABLE 1
Synergistic action of a mixture of the compound of formula Ia
with halosulfuron:

| | Ia | | Ia 150 g/ha + | |
|---|---|---|---|---|
| | 150 | Halosulfuron | halosulfuron | Expected value We |
| Test plant | g/ha | 100 g/ha | 100 g/ha | according to Colby |
| Digitaria | 75 | 25 | 90 | 81 |

TABLE 2
Synergistic action of a mixture of the compound of formula la
with glyphosate:

| | la | | la 150 g/ha + | |
|---|---|---|---|---|
| | 150 | Glyphosate | glyphosate | Expected value We |
| Test plant | g/ha | 500 g/ha | 500 g/ha | according to Colby |
| Cyperus | 0 | 75 | 80 | 75 |

TABLE 3
Synergistic action of a mixture of the compound of formula lb
with primisulfuron:

| | | | la 75 g/ha + | Expected value |
|---|---|---|---|---|
| | la | Primisulfuron | primisulfuron | We according |
| Test plant | 75 g/ha | 20 g/ha | 20 g/ha | to Colby |
| Cyperus | 10 | 90 | 95 | 91 |

Experiment Description—Pre-emergence Test:

The test plants are sown in standard soil in plastics pots under greenhouse conditions. Directly after sowing, the test compounds are applied in aqueous suspension (500 liters of water/ha). The test plants are then grown on in the greenhouse under optimum conditions. The rates of application depend on the optimum doses ascertained under field conditions and greenhouse conditions. The tests are evaluated after 26 days (% action, 100%=plants have died, 0%=no phytotoxic action). The results are given in the following Tables 4 to 7.

TABLE 4
Synergistic action of a mixture of the compound of formula la
with terbuthylazine:

| | | | la 50 g/ha + | Expected value |
|---|---|---|---|---|
| | la | Terbuthylazine | terbuthylazine | We according |
| Test plant | 50 g/ha | 200 g/ha | 200 g/ha | to Colby |
| Ipomoea | 60 | 30 | 85 | 72 |
| Polygonum | 40 | 60 | 90 | 76 |
| Xanthium | 75 | 0 | 100 | 75 |

TABLE 5
Synergistic action of a mixture of the compound of formula la
with atrazine:

| | | | la 50 g/ha + | |
|---|---|---|---|---|
| | la | Atrazine | atrazine | Expected value We |
| Test plant | 50 g/ha | 200 g/ha | 200 g/ha | according to Colby |
| Polygonum | 40 | 90 | 98 | 94 |
| Xanthium | 75 | 0 | 90 | 75 |

TABLE 6
Synergistic action of a mixture of the compound of formula lb
with terbuthylazine:

| | | | lb 37.5 g/ha + | Expected value |
|---|---|---|---|---|
| | lb 37.5 | Terbuthylazine | terbuthylazine | We according |
| Test plant | g/ha | 200 g/ha | 200 g/ha | to Colby |
| Ipomoea | 60 | 30 | 95 | 72 |
| Polygonum | 30 | 60 | 95 | 72 |
| Xanthium | 75 | 0 | 100 | 75 |

TABLE 7
Synergistic action of a mixture of the compound of formula lb
with atrazine:

| | | | lb 37.5 g/ha + | |
|---|---|---|---|---|
| | lb 37.5 | Atrazine | atrazine | Expected value We |
| Test plant | g/ha | 200 g/ha | 200 g/ha | according to Colby |
| Ipomoea | 60 | 70 | 100 | 88 |
| Xanthium | 75 | 0 | 90 | 75 |

It has surprisingly been shown that special safeners are suitable for mixing with the synergistic compositions according to the invention. The present invention accordingly relates also to a herbicidally selective composition for controlling grasses and weeds in crops of useful plants, especially in maize crops, that comprises a compound of formula 1, as appropriate one or more compounds selected from the compounds of formulae 2.1 to 2.33, and a safener (counter agent, antidote), and that protects the useful plants, but not the weeds, against the phytotoxic action of the herbicide, and also to the use of such a composition in the control of weeds in crops of useful plants.

There is also proposed in accordance with the invention a herbicidally selective composition that, in addition to comprising customary inert formulation adjuvants, such as carriers, solvents and wetting agents, comprises as active ingredient a mixture of

a) a herbicidally-synergistically effective amount of a compound of formula I and one or more compounds selected from the compounds of formulae 2.1 to 2.33 and

b) a herbicidally-antagonistically effective amount of a compound selected from the compound of formula 3.1

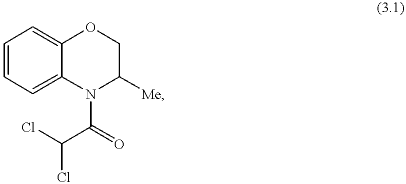

and the compound of formula 3.2

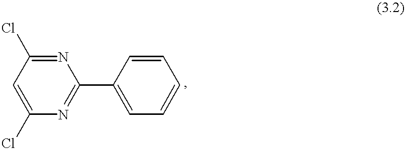

and the compound of formula 3.3

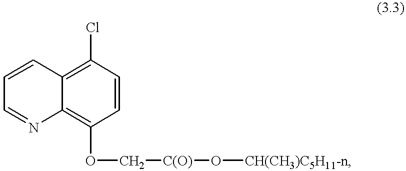

and the compound of formula 3.4

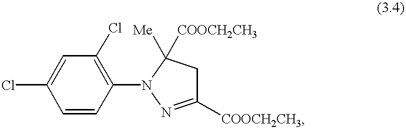

and the compound of formula 3.5

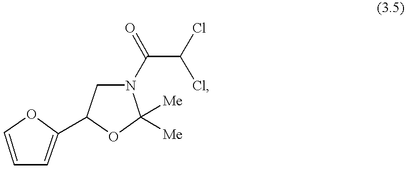

and the compound of formula 3.6

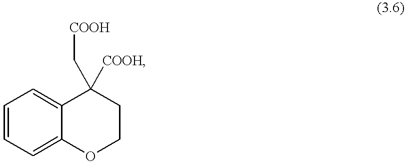

and the compound of formula 3.7

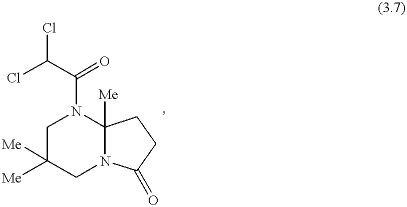

and the compound of formula 3.8

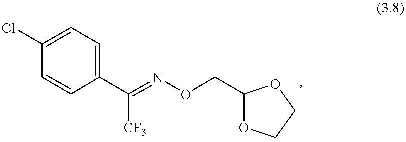

and of formula 3.9

Cl₂CHCON(CH₂CH═CH₂) (3.9),

and of formula 3.10

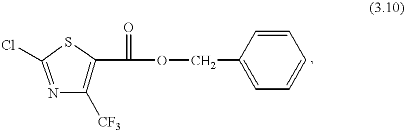

and of formula 3.11

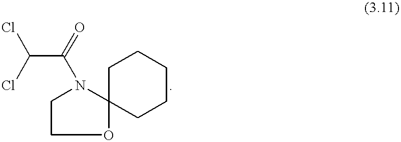

Preferred herbicidally selective compositions comprise

a) a herbicidally-synergistically effective amount of a compound of formula 1, of a compound of formula 2.2.1

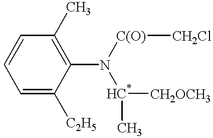

(2.2.1, aRS,1′S(−)N-(1′-methyl-2′-methoxyethyl)-N-chloroacetyl-2-ethyl-6-methylaniline), and of a compound selected from formula 2.4 wherein R₇ is chlorine, R₈ is ethyl and R₉ is isopropyl, or R₇ is chlorine, R₈ is ethyl and R₉ is tert-butyl, and formula 2.6 wherein R₁₂ is hydrogen, Z is methine, R₁₃ is methyl, Y is nitrogen, R₁₄ is fluorine, R₁₅ is hydrogen and R₁₆ is fluorine, or R₁₂ is methoxy, Z is methine, R₁₃ is methoxy, Y is methine, R₁₄ is chlorine, R₁₅ is methyl and R₁₆ is chlorine, and formula 2.7 wherein R₁₇ is —C(O)—S-n-octyl, and formula 2.13 wherein Y₁ is nitrogen, Y₂, Y₃ and Y₄ are methine, R₂₄ is dimethylaminocarbonyl and Y₅ is methine, or Y₁, Y₂, Y₃ and Y₄ are methine, R₂₄ is methoxycarbonyl and Y₅ is methine, or Y₁, Y₂, Y₃ and Y₄ are methine, R₂₄ is 3-trifluoropropyl and Y₁ is nitrogen, or Y, is nitrogen, Y₂, Y₃ and Y₄ are methine, R₂₄ is ethylsulfonyl and Y₅ is methine, or Y₁ is N—Me, Y₂ is nitrogen, Y₃ and Y₄ together are C—Cl, R₂₄ is methoxycarbonyl and Y₅ is methine, and formula 2.9, and formula 2.11 wherein R₂₂ is trifluoromethyl, and formula 2.12, and formula 2.16, and formula 2.18, and formula 2.19, and

b) a herbicidally-antagonistically effective amount of a compound of formula 3.1

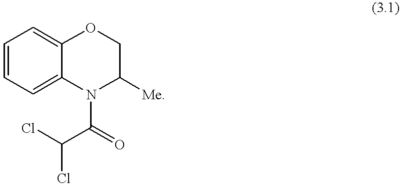

An especially preferred herbicidally selective composition comprises

a) a herbicidally-synergistically effective amount of a compound of formula I and of a compound of formula 2.2.1

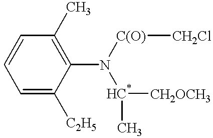

(2.2.1, aRS,1′S(−)N-(1′-methyl-2′-methoxyethyl)-N-chloroacetyl-2-ethyl-6-methylaniline), and

b) a herbicidally-antagonistically effective amount of a compound of formula 3.1

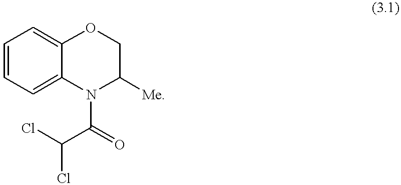

Preference is given also to herbicidally selective compositions according to the invention that comprise, as herbicidally-synergistically effective amount, a compound of formula 1, a compound of formula 2.2 and, as herbicidally-antagonistically effective amount, a compound selected from the compounds of formulae 3.1 to 3.11.

The invention relates also to a herbicidally selective composition that, in addition to comprising customary inert formulation adjuvants, such as carriers, solvents and wetting agents, comprises as active ingredient a mixture of

a) a herbicidally effective amount of a compound of formula I and

b) a herbicidally-antagonistically effective amount of a compound selected from the compound of formula 3.1

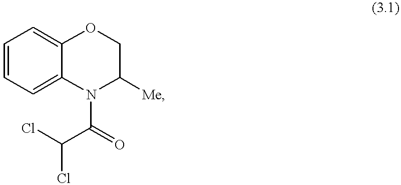

and the compound of formula 3.2

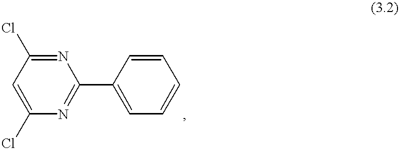

and the compound of formula 3.3

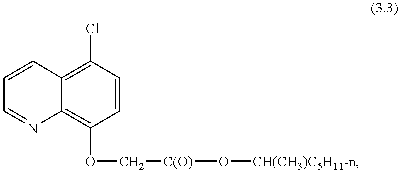

and the compound of formula 3.4

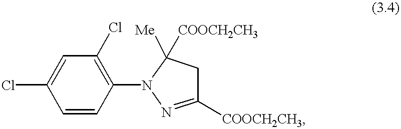

and the compound of formula 3.5

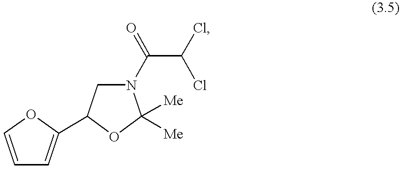

and the compound of formula 3.6

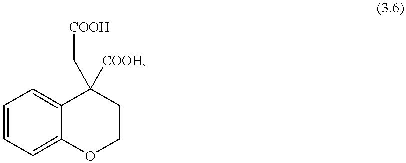

and the compound of formula 3.7

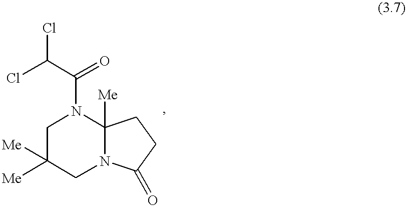

and the compound of formula 3.8

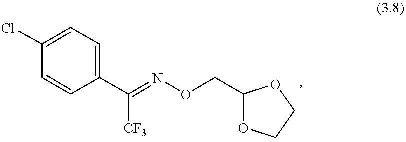

and of formula 3.9

Cl₂CHCON(CH₂CH═CH₂) (3.9),

and of formula 3.10

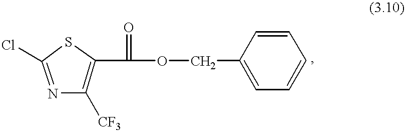

and of formula 3.11

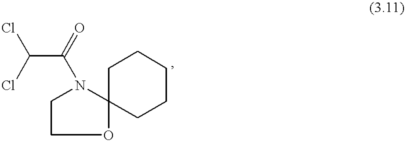

The invention relates also to a method for the selective control of weeds in crops of useful plants, which comprises treating the useful plants, seeds or cuttings thereof, or the area of cultivation thereof, with a herbicidally effective amount of the herbicide of formula 1, as appropriate one or more herbicides selected from the compounds of formulae 2.1 to 2.33, and a herbicidally-antagonistically effective amount of a safener of formulae 3.1 to 3.11.

The compounds of formulae 3.1 to 3.11 are known and are described, for example, in the Pesticide Manual, eleventh ed., British Crop Protection Council, 1997 under the entry numbers 61 (formula 3.1, benoxacor), 304 (formula 3.2, fenclorim), 154 (formula 3.3, cloquintocet), 462 (formula 3.4, mefenpyr-diethyl), 377 (formula 3.5, furilazol), 363 (formula 3.8, fluxofenim), 213 (formula 3.9, dichlormid) and 350 (formula 3.10, flurazole). The compound of formula 3.11 is known by the name MON 4660 (Monsanto).

The compound of formula 3.6 (AC 304415) is described, for example, in EP-A-0 613 618, and the compound of formula 3.7 in DE-A-2 948 535.

As crop plants that can be protected by the safeners of formulae 3.1 to 3.11 against the damaging effect of the above-mentioned herbicides there come into consideration especially cereals, cofton, soybeans, sugar beet, sugar cane, plantation crops, rape, maize and rice, more especially maize. “Crops” are to be understood to mean also those crops which have been made tolerant to herbicides or classes of herbicides as a result of conventional methods of breeding or genetic engineering.

The weeds to be controlled may be both monocotyledonous and dicotyledonous weeds, e.g. Stellaria, Agrostis, Digitaria, Avena, Apera, Brachiaria, Phalaris, Setaria, Sinapis, Lolium, Solanum, Echinochloa, Scirpus, Monochoria, Sagittaria, Panicum, Bromus, Alopecurus, Sorghum halepense, Sorghum bicolor, Rottboellia, Cyperus, Abutilon, Sida, Xanthium, Amaranthus, Chenopodium, Ipomoea, Chrysanthemum, Galium, Viola and Veronica.

Areas of cultivation include the areas of ground on which the crop plants are already growing or which have already been sown with the seeds of those crop plants, as well as ground intended for cultivation with such crop plants.

Depending on the intended use, a safener of formula 3.1 to 3.11 can be used in the pretreatment of the seed of the crop plant (dressing of the seeds or cuttings) or can be introduced into the soil before or after sowing. It can, however, also be applied, either alone or together with the herbicide, after emergence of the plants. The treatment of the plants or seeds with the safener can therefore in principle be carried out independently of the time at which the herbicide is applied. The plants can, however, also be treated by simultaneous application of herbicide and safener (e.g. in the form of a tank mixture). The ratio of the rate of application of safener to the rate of application of herbicide depends largely on the method of application. In the case of field treatment, which is carried out either using a tank mixture comprising a combination of safener and herbicide or by separate application of safener and herbicide, the ratio of herbicides to safener is generally from 100:1 to 1:10, preferably from 20:1 to 1:1. In the case of field treatment it is usual to apply from 0.001 to 1.0 kg of safener/ha, preferably from 0.001 to 0.25 kg of safener/ha.

The rate of application of herbicides is generally from 0.001 to 2 kg/ha, but preferably from 0.005 to 0.5 kg/ha.

The compositions according to the invention are suitable for all methods of application conventionally used in agriculture, e.g. pre-emergence application, post-emergence application and seed dressing.

In the case of seed dressing, generally from 0.001 to 10 g of safener/kg of seed, preferably from 0.05 to 2 g of safener/kg of seed, are applied. When the safener is applied in liquid form shortly before sowing, with soaking of the seeds, then advantageously the safener solutions used contain the active ingredient in a concentration of from 1 to 10 000 ppm, preferably from 100 to 1000 ppm.

For the purpose of application, the safeners of formulae 3.1 to 3.11 or combinations of those safeners with the herbicide of formula I and one or more herbicides selected from formulae 2.1 to 2.33 are advantageously formulated together with adjuvants customary in formulation technology, e.g. into emulsifiable concentrates, coatable pastes, directly sprayable or dilutable solutions, dilute emulsions, wettable powders, soluble powders, dusts, granules or microcapsules.

Such formulations are described, for example, in WO 97/34485, pages 9 to 13. The formulations are prepared in known manner, e.g. by intimately mixing and/or grinding the active ingredients with liquid or solid formulation adjuvants, e.g. solvents or solid carriers. In addition, surface-active compounds (surfactants) can also be used in the preparation of the formulations. Solvents and solid carriers suitable for that purpose are mentioned, e.g., in WO 97/34485, page 6.

Depending on the nature of the compounds of formulae 1, 2.1 to 2.33 and 3.1 to 3.11 to be formulated, there come into consideration as surface-active compounds non-ionic, cationic and/or anionic surfactants and surfactant mixtures having good emulsifying, dispersing and wetting properties. Examples of suitable anionic, non-ionic and cationic surfactants are listed, for example, on pages 7 and 8 of WO 97/34485. Also suitable for the preparation of the herbicidal compositions according to the invention are the surfactants conventionally employed in formulation technology, which are described, inter alia, in “McCutcheon's Detergents and Emulsifiers Annual” MC Publishing Corp., Ridgewood N.J., 1981, Stache, H., “Tensid-Taschenbuch”, Carl Hanser Verlag, MunichNienna, 1981 and M. and J. Ash, “Encyclopedia of Surfactants”, Vol. I-III, Chemical Publishing Co., New York, 1980-81.

The herbicidal formulations usually contain from 0.1 to 99% by weight, especially from 0.1 to 95% by weight, of active ingredient mixture comprising a compound of formula 1, a compound selected from the compounds of formulae 2.1 to 2.33 and the compounds of formulae 3.1 to 3.11, from 1 to 99% by weight of a solid or liquid formulation adjuvant and from 0 to 25% by weight, especially from 0.1 to 25% by weight, of a surfactant. Whereas commercial products are usually formulated as concentrates, the end user will normally employ dilute formulations.

The compositions may also comprise further ingredients, such as stabilisers, e.g. vegetable oils or epoxidised vegetable oils (epoxidised coconut oil, rapeseed oil or soybean oil), anti-foams, e.g. silicone oil, preservatives, viscosity regulators, binders, tackifiers, and also fertilisers or other active ingredients. For the use of safeners of formulae 3.1 to 3.11, or of compositions comprising them, in the protection of crop plants against the damaging effects of herbicides of formulae I and 2.1 to 2.33, various methods and techiques come into consideration, such as, for example, the following:

i) Seed Dressing

a) Dressing of the seeds with a wettable powder formulation of a compound of formulae 3.1 to 3.11 by shaking in a vessel until uniformly distributed over the seed surface (dry dressing). In that procedure approximately from 1 to 500 g of compound of formulae 3.1 to 3.11 (4 g to 2 kg of wettable powder) are used per 100 kg of seed.

b) Dressing of the seeds with an emulsifiable concentrate of a compound of formulae 3.1 to 3.11 according to method a) (wet dressing).

c) Dressing by immersing the seeds for from 1 to 72 hours in a liquor comprising from 100 to 1000 ppm of a compound of formulae 3.1 to 3.11 and optionally subsequently drying the seeds (immersion dressing).

Dressing the seed or treating the germinated seedling are naturally the preferred methods of application, because treatment with the active ingredients is directed entirely at the target crop. Generally from 1 to 1000 g of antidote, preferably from 5 to 250 g of antidote, are used per 100 kg of seed, but depending on the methodology, which also enables the addition of other active ingredients or micronutrients, the concentration limits indicated can be varied up or down (repeat dressing).

ii) Application as a Tank Mixture

A liquid formulation of a mixture of antidote and herbicide is used (ratio by weight of the one to the other from 10:1 to 1:100), the rate of application of herbicide being from 0.005 to 5.0 kg per hectare. Such tank mixtures are applied before or after sowing.

iii) Application to the Seed Furrow

The compounds of formulae 3.1 to 3.11 are introduced into the open, sown seed furrow in the form of an emulsifiable concentrate, wettable powder or granules. Once the seed furrow has been covered over, the herbicide is applied in the usual manner in the pre-emergence process.

iv) Controlled Release of Active Ingredient

The compounds of formulae 3.1 to 3.11 are applied in solution to mineral granule carriers or polymerised granules (urea/formaldehyde) and dried. If desired, it is also possible to apply a coating that allows the active ingredient to be released in metered amounts over a specific period of time (coated granules).

Preferred formulations have especially the following compositions: (%=percent by weight)

Emulsifiable concentrates:

| | |
|---|---|
| active ingredient mixture: | 1 to 90%, preferably 5 to 20% |
| surfactant: | 1 to 30%, preferably 10 to 20% |
| liquid carrier: | 5 to 94%, preferably 70 to 85% |

Dusts:

| | |
|---|---|
| active ingredient mixture: | 0.1 to 10%, preferably 0.1 to 5% |
| solid carrier: | 99.9 to 90%, preferably 99.9 to 99% |

Suspension concentrates:

| | |
|---|---|
| active ingredient mixture: | 5 to 75%, preferably 10 to 50% |
| water: | 94 to 24%, preferably 88 to 30% |
| surfactant: | 1 to 40%, preferably 2 to 30% |

Wettable powders:

| | |
|---|---|
| active ingredient mixture: | 0.5 to 90%, preferably 1 to 80% |
| surfactant: | 0.5 to 20%, preferably 1 to 15% |
| solid carrier: | 5 to 95%, preferably 15 to 90% |

Granules:

| | |
|---|---|
| active ingredient mixture: | 0.1 to 30%, preferably 0.1 to 15% |
| solid carrier: | 99.5 to 70%, preferably 97 to 85% |

The following Examples illustrate the invention further, but do not limit the invention.

Formulation Examples For Mixtures of Herbicides of Formula I, Herbicides of Formulae 2.1 to 2.33 and safeners of formulae 3.1 to 3.11 (%=percent by weight)

| F1. Emulsifiable concentrates | a) | b) | c) | d) |
|---|---|---|---|---|
| active ingredient mixture | 5% | 10% | 25% | 50% |
| calcium dodecylbenzenesulfonate | 6% | 8% | 6% | 8% |
| castor oil polyglycol ether | 4% | — | 4% | 4% |
| (36 mol of ethylene oxide) | | | | |
| octylphenol polyglycol ether | — | 4% | — | 2% |
| (7-8 mol of ethylene oxide) | | | | |
| cyclohexanone | — | — | 10% | 20% |
| aromatic hydrocarbon mixture | 85% | 78% | 55% | 16% |
| C₉-C₁₂ | | | | |

Emulsions of any desired concentration can be obtained from such concentrates by dilution with water.

| F2. Solutions | a) | b) | c) | d) |
|---|---|---|---|---|
| active ingredient mixture | 5% | 10% | 50% | 90% |
| 1-methoxy-3-(3-methoxy- | — | 20% | 20% | — |
| propoxy)-propane | | | | |
| polyethylene glycol MW 400 | 20% | 10% | — | — |
| N-methyl-2-pyrrolidone | — | — | 30% | 10% |
| aromatic hydrocarbon mixture | 75% | 60% | — | — |
| C₉-C₁₂ | | | | |

The solutions are suitable for use in the form of microdrops.

| F3. Wettable powders | a) | b) | c) | d) |
|---|---|---|---|---|
| active ingredient mixture | 5% | 25% | 50% | 80% |
| sodium lignosulfonate | 4% | — | 3% | — |
| sodium lauryl sulfate | 2% | 3% | — | 4% |
| sodium diisobutylnaphthalene- | — | 6% | 5% | 6% |
| sulfonate | | | | |
| octylphenol polyglycol ether | — | 1% | 2% | — |
| (7-8 mol of ethylene oxide) | | | | |
| highly dispersed silicic acid | 1% | 3% | 5% | 10% |
| kaolin | 88% | 62% | 35% | — |

The active ingredient is mixed thoroughly with the adjuvants and the mixture is thoroughly ground in a suitable mill, affording wettable powders which can be diluted with water to give suspensions of any desired concentration.

| F4. Coated granules | a) | b) | c) |
|---|---|---|---|
| active ingredient mixture | 0.1% | 5% | 15% |
| highly dispersed silicic acid | 0.9% | 2% | 2% |
| inorganic carrier | 99.0% | 93% | 83% |
| ( [symbol] 0.1-1 mm) | | | |
| e.g. CaCO₃ or SiO₂ | | | |

The active ingredient is dissolved in methylene chloride and applied to the carrier by spraying, and the solvent is then evaporated off in vacuo.

| F5. Coated granules | a) | b) | c) |
|---|---|---|---|
| active ingredient mixture | 0.1% | 5% | 15% |
| polyethylene glycol MW 200 | 1.0% | 2% | 3% |
| highly dispersed silicic acid | 0.9% | 1% | 2% |
| inorganic carrier | 98.0% | 92% | 80% |
| ( [symbol] 0.1-1 mm) | | | |
| e.g. CaCO₃ or SiO₂ | | | |

The finely ground active ingredient is uniformly applied, in a mixer, to the carrier moistened with polyethylene glycol. Non-dusty coated granules are obtained in this manner.

| F6. Extruder granules | a) | b) | c) | d) |
|---|---|---|---|---|
| active ingredient mixture | 0.1% | 3% | 5% | 15% |
| sodium lignosulfonate | 1.5% | 2% | 3% | 4% |
| carboxymethylcellulose | 1.4% | 2% | 2% | 2% |
| kaolin | 97.0% | 93% | 90% | 79% |

The active ingredient is mixed and ground with the adjuvants, and the mixture is moistened with water. The mixture is extruded and then dried in a stream of air.

| F7. Dusts | a) | b) | c) |
|---|---|---|---|
| active ingredient mixture | 0.1% | 1% | 5% |
| talcum | 39.9% | 49% | 35% |
| kaolin | 60.0% | 50% | 60% |

Ready-to-use dusts are obtained by mixing the active ingredient with the carriers and grinding the mixture in a suitable mill.

| F8. Suspension concentrates | a) | b) | c) | d) |
|---|---|---|---|---|
| active ingredient mixture | 3% | 10% | 25% | 50% |
| ethylene glycol | 5% | 5% | 5% | 5% |
| nonylphenol polyglycol ether | — | 1% | 2% | — |
| (15 mol of ethylene oxide) | | | | |
| sodium lignosulfonate | 3% | 3% | 4% | 5% |
| carboxymethylcellulose | 1% | 1% | 1% | 1% |
| 37% aqueous formaldehyde | 0.2% | 0.2% | 0.2% | 0.2% |
| solution | | | | |
| silicone oil emulsion | 0.8% | 0.8% | 0.8% | 0.8% |
| water | 87% | 79% | 62% | 38% |

The finely ground active ingredient is intimately mixed with the adjuvants, giving a suspension concentrate from which suspensions of any desired concentration can be obtained by dilution with water.

It is often more practical for the compounds of formulae 1, 2.1 to 2.33 and 3.1 to 3.11 to be formulated separately and then to be brought together in the desired mixing ratio in the applicator in the form of a “tank mixture” in water shortly before application.

The ability of the safeners of formulae 3.1 to 3.11 to protect crop plants against the phytotoxic action of herbicides of formula I is illustrated in the following Examples.

Biological Example: Safening Action

The test plants are grown in plastics pots under greenhouse conditions to the 4-leaf stage. At that stage, the herbicides alone, and the mixtures of the herbicides with the test compounds that are to be tested as safeners, are applied to the test plants. The application is in the form of an aqueous suspension of the test compounds prepared from a 25% wettable powder (Example F3, b)) with 500 liters of water/ha. 3 weeks after application, the phytotoxic action of the herbicides on the crop plants, e.g. maize and cereals, is evaluated using a percentage scale. 100% denotes that the test plant has died, 0% denotes no phytotoxic action.

The results obtained in this test demonstrate that damage to the crop plant caused by the herbicide of formula I in combination with one or more herbicides selected from formulae 2.1 to 2.33 can be significantly reduced by the compounds of formulae 3.1 to 3.11.

The same results are obtained when the mixtures are formulated in accordance with Examples F1, F2 and F4 to F8.

1. A synergistic herbicidal composition that, in addition to comprising customary inert formulation adjuvants, comprises as active ingredient a mixture of
a) a compound of formula I 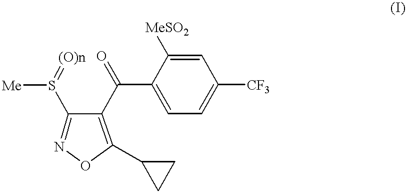
wherein n is 0 or 1; and
b) a synergistically effective amount of one or more compounds selected from a compound of formula 2.2 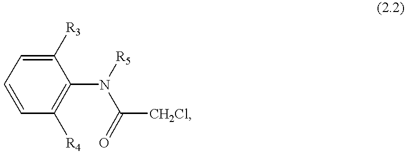
wherein R₃ is ethyl, R₄ is methyl or ethyl and R₅ is —CH(Me)—CH₂OMe, <S>—CH(Me)—CH₂OMe, CH₂OMe or CH₂O—CH₂CH₃;
and a compound of formula 2.3 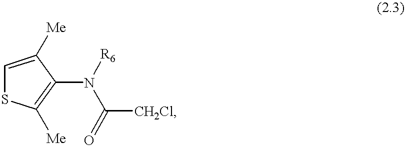
wherein R₆ is CH(Me)—CH₂OMe or <S>CH(Me)—CH₂OMe;
and a compound of formula 2.4 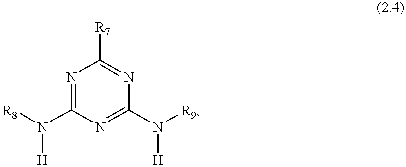
wherein R₇ is chlorine or SMe, R₈ is ethyl and R₉ is ethyl, isopropyl or tert-butyl;
and a compound of formula 2.5 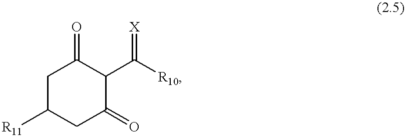
wherein R₁₀ is ethyl or n-propyl, R₁₁ is COO⁻ ½ Ca⁺⁺, —CH₂—CH(Me)S—CH₂CH₃ or the group 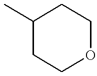
and X is oxygen, N—O—CH₂CH₃ or N—O—CH₂CH═CH—Cl;
and a compound of formula 2.6 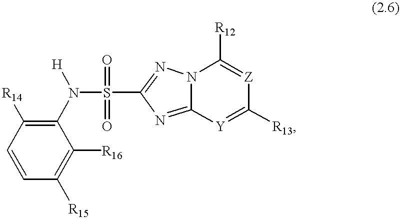
wherein R₁₂ is hydrogen, methoxy or ethoxy, R₁₃ is Me, methoxy or fluorine, R₁₄ is COOMe, fluorine or chlorine, R₁₅ is hydrogen or Me, Y is methine or nitrogen, Z is methine or nitrogen and R₁₆ is fluorine or chlorine;
and a compound of formula 2.7 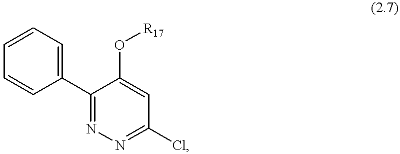
wherein R₁₇ is hydrogen or —C(O)—S-n-octyl;
and a compound of formula 2.8 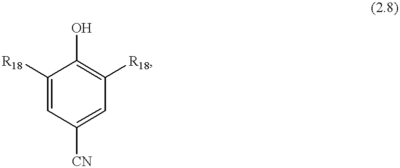
wherein R₁₈ is bromine or iodine;
and a compound of formula 2.9 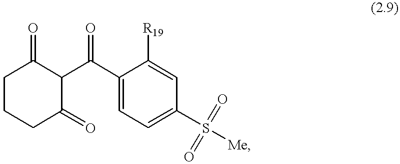
wherein R₁₉ is chlorine or nitro;
and a compound of formula 2.10 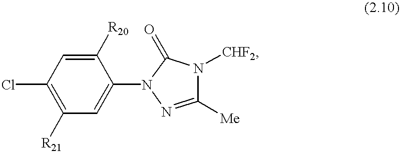
wherein R₂₀ is fluorine or chlorine and R₂₁ is —CH₂—CH(Cl)—COOCH₂CH₃ or —NH—SO₂Me;
and a compound of formula 2.11 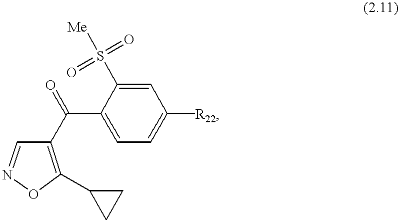
wherein R₂₂ is trifluoromethyl or chlorine;
and a compound of formula 2.12 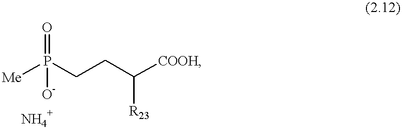
wherein R₂₃ is NH₂ or <S>NH₂;
and a compound of formula 2.13 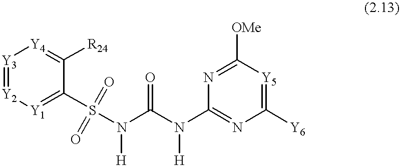
wherein Y₁ is nitrogen, methine or N—Me, Y₂ is nitrogen, methine or C—I, Y₃ is methine, Y₄ is methine, or Y₃ and Y₄ together are sulfur or C—Cl, Y₅ is nitrogen or methine, Y₆ is methyl or methoxy and R₂₄ is CONMe₂, COOMe, CH₂—CH₂CF₃ or SO₂CH₂CH₃, or sodium salts thereof;
and the compound of formula 2.14 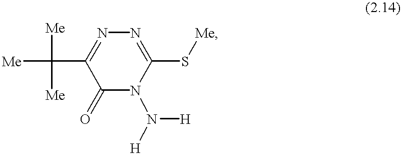
and the compound of formula 2.15 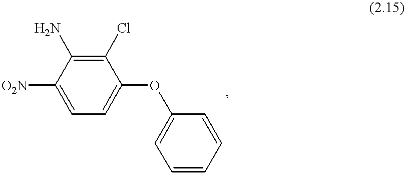
and the compound of formula 2.16 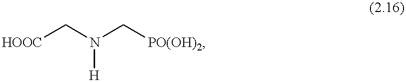
and the compound of formula 2.17 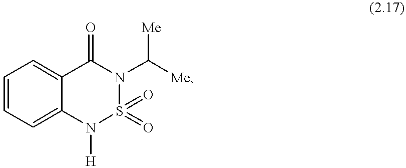
and the compound of formula 2.18 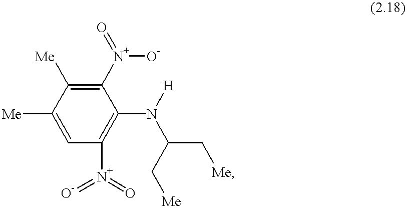
and the compound of formula 2.19 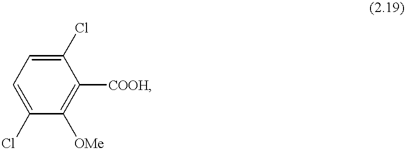
and the compound of formula 2.20 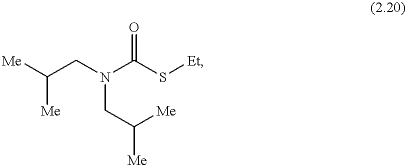
and the compound of formula 2.21 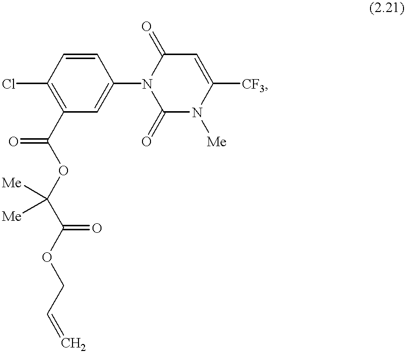
and the compound of formula 2.22 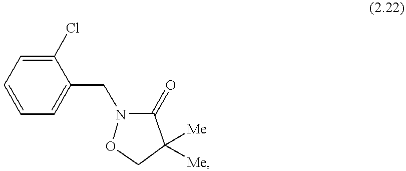
and the compound of formula 2.23 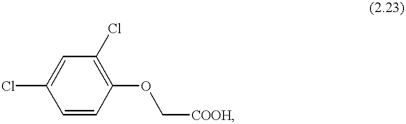
and the compound of formula 2.24 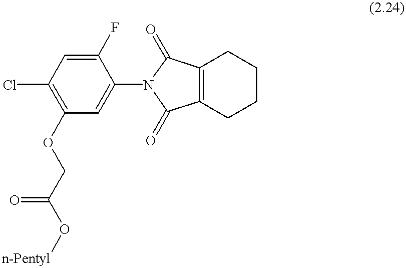
and the compound of formula 2.25 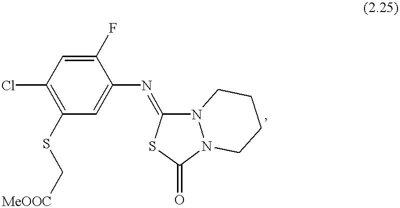
and the compound of formula 2.26 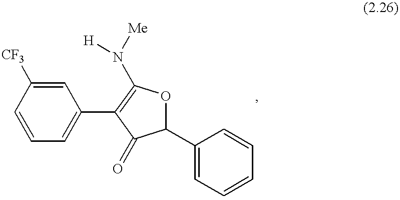
and the compound of formula 2.27 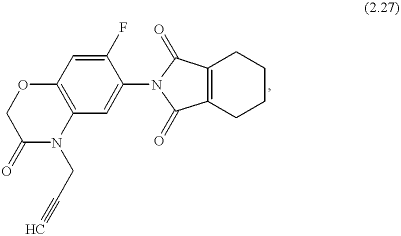
and the compound of formula 2.28 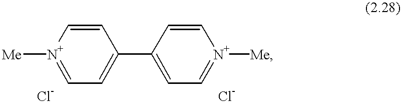
and the compound of formula 2.29 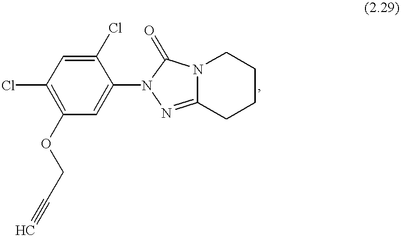
and the compound of formula 2.30 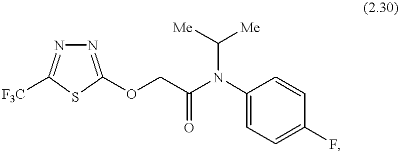
and the compound of formula 2.31 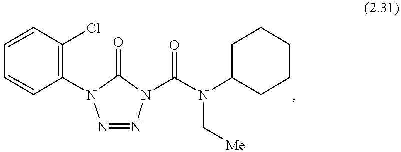
and the compound of formula 2.32 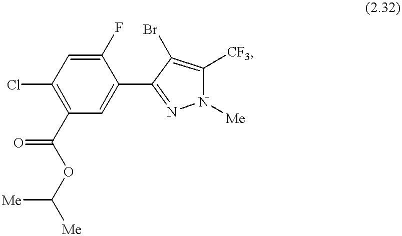
and the compound of formula 2.33

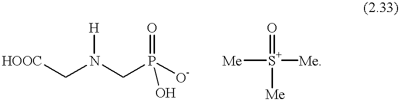

2. A herbicidal composition according to claim 1, comprising a compound of formula I and a synergistically effective amount either of a compound of formula 2.21 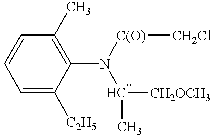
(2.2.1, aRS,1′S(−)N-(1′-methyl-2′-methoxyethyl)-N-chloroacetyl-2-ethyl-6-methylaniline), or of a compound of formula 2.2.2 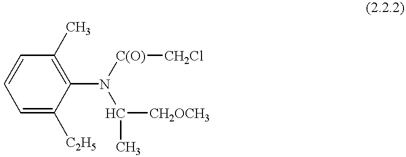
or of a compound of formula 2.2 wherein R₃ is ethyl, R₄ is methyl and R₅ is ethoxymethyl, or of a compound of formula 2.2 wherein R₃ is ethyl, R₄ is ethyl and R₅ is methoxymethyl, or of a compound of formula 2.3, or of a compound of formula 2.4 wherein R₇ is chlorine, R₈ is ethyl and R₉ is isopropyl, or R₇ is chlorine, R₈ is ethyl and R₉ is tert-butyl, or of a compound of formula 2.6 wherein R₁₂ is hydrogen, Z is methine, R₁₃ is methyl, Y is nitrogen, R₁₄ is fluorine, R₁₅ is hydrogen and R₁₆ is fluorine, or R₁₂ is methoxy, Z is methine, R₁₃ is methoxy, Y is methine, R₁₄ is chlorine, R₁₅ is methyl and R₁₆ is chlorine, or of a compound of formula 2.7 wherein R₁₇ is —C(O)—S-n-octyl, or of a compound of formula 2.9, or of a compound of formula 2.11 wherein R₂₂ is trifluoromethyl, or of a compound of formula 2.12, or of a compound of formula 2.13 wherein Y₁ is nitrogen, Y₂, Y₃ and Y₄ are methine, R₂₄ is dimethylaminocarbonyl and Y₅ is methine, or Y₁, Y₂, Y₃ and Y₄ are methine, R₂₄ is methoxycarbonyl and Y₅ is methine, or Y₁, Y₂, Y₃ and Y₄ are methine, R₂₄ is 3-trifluoropropyl and Y₅ is nitrogen, or Y₁ is nitrogen, Y₂, Y₃ and Y₄ are methine, R₂₄ is ethylsulfonyl and Y₅ is methine, or Y, is N—Me, Y₂ is nitrogen, Y₃ and Y₄ together are C—Cl, R₂₄ is methoxycarbonyl and Y₅ is methine, or of a compound of formula 2.16, or of a compound of formula 2.18, or of a compound of formula 2.19, or of a compound of formula 2.30.

3. A herbicidal composition according to claim 1, comprising a compound of formula 1, a compound of formula 2.2.1 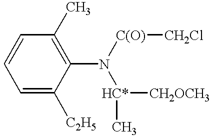
(2.2.1, aRS,1′S(−)N-(1′-methyl-2′-methoxyethyl)-N-chloroacetyl-2-ethyl-6-methylaniline), and a compound selected from formula 2.4 wherein R₇ is chlorine, R₈ is ethyl and R₉ is isopropyl, or R₇ is chlorine, R₈ is ethyl and R₉ is tert-butyl, and formula 2.6 wherein R₁₂ is hydrogen, Z is methine, R₁₃ is methyl, Y is nitrogen, R₁₄ is fluorine, R₁₅ is hydrogen and R₁₆ is fluorine, or R₁₂ is methoxy, Z is methine, R₁₃ is methoxy, Y is methine, R₁₄ is chlorine, R₁₅ is methyl and R₁₆ is chlorine, and formula 2.7 wherein R₁₇ is —C(O)—S-n-octyl, and formula 2.13 wherein Y₁ is nitrogen, Y₂, Y₃ and Y₄ are methine, R₂₄ is dimethylaminocarbonyl and Y₅ is methine, or Y₁, Y₂, Y₃ and Y₄ are methine, R₂₄ is methoxycarbonyl and Y₅ is methine, or Y₁, Y₂, Y₃ and Y₄ are methine, R₂₄ is 3-trifluoropropyl and Y₅ is nitrogen, or Y₁ is nitrogen, Y₂, Y₃ and Y₄ are methine, R₂₄ is ethylsulfonyl and Y₅ is methine, or Y₁ is N—Me, Y₂ is nitrogen, Y₃ and Y₄ together are C—Cl, R₂₄ is methoxycarbonyl and Y₅ is methine, and formula 2.9, and formula 2.11 wherein R₂₂ is trifluoromethyl, and formula 2.12, and formula 2.16, and formula 2.18, and formula 2.19.

4. A herbicidal composition according to claim 1, comprising a compound of formula I and a synergistically effective amount of a compound of formula 2.2.1 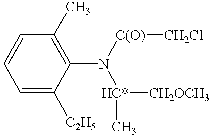
(2.2.1, aRS,1′S(−)N-(1′-methyl-2′-methoxyethyl)-N-chloroacetyl-2-ethyl-6-methylaniline).

5. A herbicidal composition according to claim 1, wherein the compound of formula I is present in a ratio by weight of from 1:2000 to 2000:1 with respect to the compounds of formulae 2.1 to 2.33.

6. A method of controlling undesired plant growth in crops of useful plants, which comprises allowing a herbicidally effective amount of a composition according to claim 1 to act on the crop plant or the locus thereof.

7. A method according to claim 6, wherein the crop plant is maize.

8. A method according to claim 6, wherein the crops of useful plants are treated with the mentioned composition at rates of application corresponding to from 1 to 5000 g of active ingredient per hectare.

9. A herbicidally selective composition that, in addition to comprising customary inert formulation adjuvants, such as carriers, solvents and wetting agents, comprises as active ingredient a mixture of
a) a herbicidally-synergistically effective amount of a compound of formula I according to claim 1 and one or more compounds selected from the compounds of formulae 2.1 to 2.33 according to claim 1 and
b) a herbicidally-antagonistically effective amount of a compound selected from the compound of formula 3.1 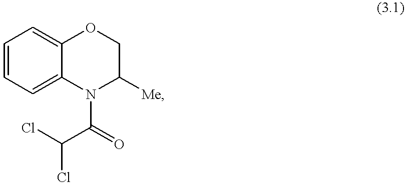
and the compound of formula 3.2 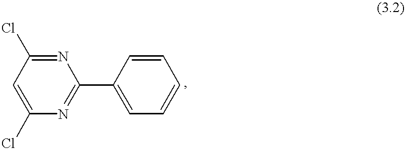
and the compound of formula 3.3 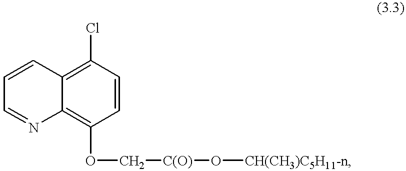
and the compound of formula 3.4 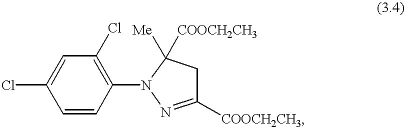
and the compound of formula 3.5 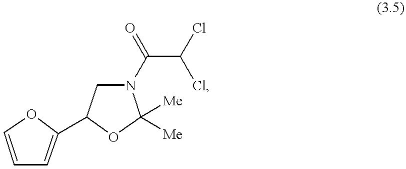
and the compound of formula 3.6 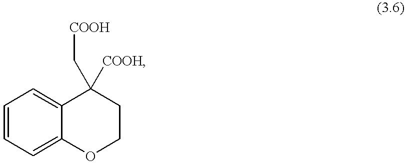
and the compound of formula 3.7 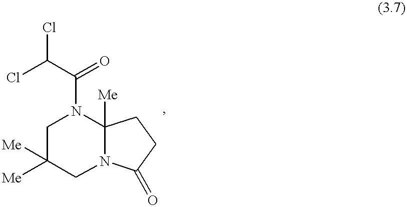
and the compound of formula 3.8 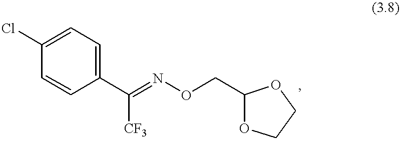
and of formula 3.9
Cl₂CHCON(CH₂CH═CH₂) (3.9),
and of formula 3.10 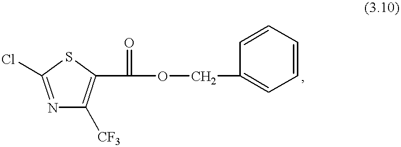
and of formula 3.11

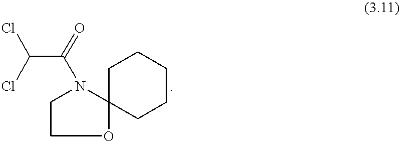

10. A method for the selective control of weeds and grasses in crops of useful plants, which comprises treating the useful plants, seeds or cuttings thereof, or the area of cultivation thereof, with a herbicidally-synergistically effective amount of a composition according to claim 9.

11. A method according to claim 10, wherein the rate of application of herbicides is from 1 to 5000 g/ha and the rate of application of safener is from 0.001 to 0.5 kg/ha.

12. A method according to claim 10, wherein the crops of useful plants are maize.

13. A herbicidal composition according to claim 9, which comprises
a) a herbicidally-synergistically effective amount of a compound of formula 1, of a compound of formula 2.2.1 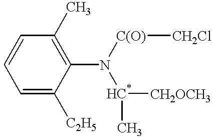
(2.2.1, aRS,1′S(−)N-(1′-methyl-2′-methoxyethyl)-N-chloroacetyl-2-ethyl-6-methylaniline), and of a compound selected from formula 2.4 wherein R₇ is chlorine, R₈ is ethyl and R₉ is isopropyl, or R₇ is chlorine, R₈ is ethyl and R₉ is tert-butyl, and formula 2.6 wherein R₁₂ is hydrogen, Z is methine, R₁₃ is methyl, Y is nitrogen, R₁₄ is fluorine, R₁₅ is hydrogen and R₁₆ is fluorine, or R₁₂ is methoxy, Z is methine, R₁₃ is methoxy, Y is methine, R₁₄ is chlorine, R₁₅ is methyl and R₁₆ is chlorine, and formula 2.7 wherein R₁₇ is —C(O)—S-n-octyl, and formula 2.13 wherein Y₁ is nitrogen, Y₂, Y₃ and Y₄ are methine, R₂₄ is dimethylaminocarbonyl and Y₅ is methine, or Y₁, Y₂, Y₃ and Y₄ are methine, R₂₄ is methoxycarbonyl and Y₅ is methine, or Y₁, Y₂, Y₃ and Y₄ are methine, R₂₄ is 3-trifluoropropyl and Y₅ is nitrogen, or Y₁ is nitrogen, Y₂, Y₃ and Y₄ are methine, R₂₄ is ethylsulfonyl and Y₅ is methine, or Y₁ is N—Me, Y₂ is nitrogen, Y₃ and Y₄ together are C—Cl, R₂₄ is methoxycarbonyl and Y₅ is methine, and formula 2.9, and formula 2.11 wherein R₂₂ is trifluoromethyl, and formula 2.12, and formula 2.16, and formula 2.18, and formula 2.19, and
b) a herbicidally-antagonistically effective amount of a compound of formula 3.1

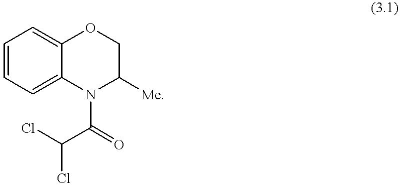

14. A herbicidal composition according to claim 9, which comprises
a) a herbicidally-synergistically effective amount of a compound of formula 1, of a compound of formula 2.2.1 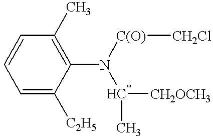
(2.2.1, aRS,1′S(−)N-(1′-methyl-2′-methoxyethyl)-N-chloroacetyl-2-ethyl-6-methylaniline, and
b) a herbicidally-antagonistically effective amount of a compound of formula 3.1

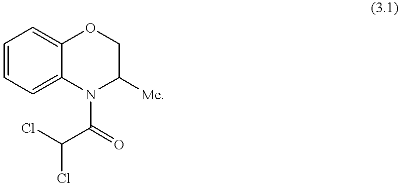

15. A herbicidal composition according to claim 9, which comprises, as herbicidally-synergistically effective amount, a compound of formula I and a compound of formula 2.2.

16. A herbicidally selective composition that, in addition to comprising customary inert formulation adjuvants, such as carriers, solvents and wetting agents, comprises as active ingredient a mixture of
a) a herbicidally effective amount of a compound of formula I and
b) a herbicidally-antagonistically effective amount of a compound selected from the compound of formula 3.1 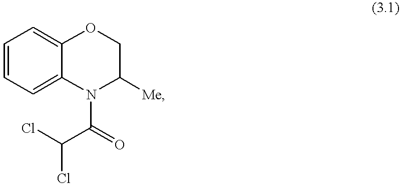
and the compound of formula 3.2 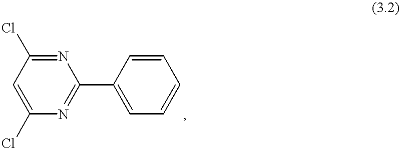
and the compound of formula 3.3 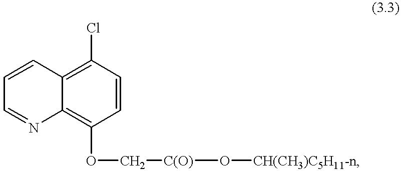
and the compound of formula 3.4 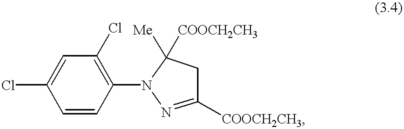
and the compound of formula 3.5 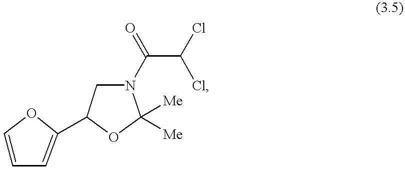
and the compound of formula 3.6 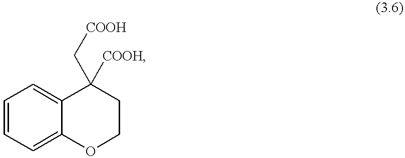
and the compound of formula 3.7 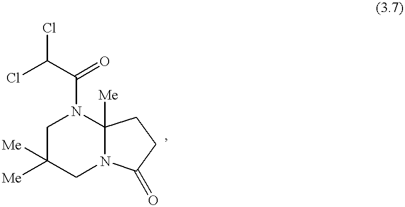
and the compound of formula 3.8 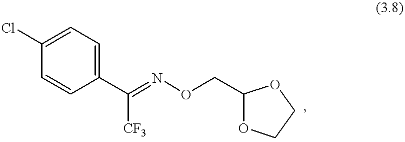
and of formula 3.9
Cl₂CHCON(CH₂CH═CH₂) (3.9),
and of formula 3.10 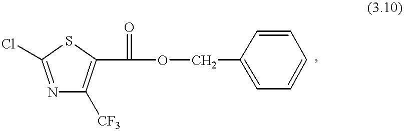
and of formula 3.11

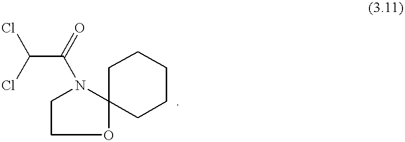

17. A method for the selective control of weeds and grasses in crops of useful plants, which comprises treating the useful plants, seeds or cuttings thereof, or the area of cultivation thereof, with a herbicidally-synergistically effective amount of a composition according to claim 16.
